(19) United States
(12) Patent Application Publication
(10) Pub. No.: US 2015/0134449 A1
(43) Pub. Date: May 14, 2015

(54) FINANCIAL CONVERSATION MANAGEMENT SYSTEMS AND METHODS

(71) Applicant: SRI International, Menlo Park, CA (US)

(72) Inventors: Zor Gorelov, North Caldwell, NJ (US); Sasha Caskey, New York, NY (US); Dror Oren, Mountain View, CA (US); William Mark, San Mateo, CA (US)

(73) Assignee: SRI International, Menlo Park, CA (US)

(21) Appl. No.: 14/079,365

(22) Filed: Nov. 13, 2013

(51) Int. Cl. G06Q 30/02

(52) U.S. Cl. CPC G06Q 30/0255
USPC 705/14.53

(57) ABSTRACT

Example financial conversation management systems and methods are described. In one implementation, a method receives a request from a user and identifies financial data associated with the user. The method determines an answer to the request from the user and infers a user intent based on the financial data associated with the user. An offer is selected for the user based on the user intent.

### TECHNICAL FIELD

The present disclosure relates to systems and methods that support conversational interaction with a user to infer the user's intent.

### BACKGROUND

Financial institutions offer a variety of products and services to their customers. Many of these products and services are appropriate for certain groups of customers. For example, customers making a large purchase may be interested in a loan, while customers with an existing loan may be interested in refinancing the loan when interest rates decline. Existing systems send offers for products and services to large groups of customers without any knowledge of the customer's current desires or intent. Typically, many customers will disregard these offers because they are not currently interested in the product or service offered. Therefore, it is desirable to communicate targeted offers to particular users based on the user's current desires or intent.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an environment within which an example embodiment may be implemented.

FIG. 2 is a block diagram depicting an embodiment of a financial conversation manager.

FIG. 3 is a block diagram depicting an embodiment of a financial institution offer manager.

FIGS. 4A and 4B represent a flow diagram depicting an embodiment of a method for interacting with a user and communicating an offer to the user.

FIG. 5 is a diagram depicting an embodiment of data collected and generated during an interaction with a user.

FIGS. 6A and 6B represent a flow diagram depicting another embodiment of a method for interacting with a user and communicating an offer to the user.

FIG. 7 is a diagram depicting another embodiment of data collected and generated during an interaction with a user.

FIG. 8 is a flow diagram depicting an embodiment of a method for selecting an offer to present to a user.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein support conversational interaction with a user to infer the user's intent. As used herein, the inferring of the user's intent relates to predicting the user's actual intent when making a request during a conversation. For example, the user's intent may be to determine the user's account balance at a financial institution or a purchase history with a merchant. The described systems and methods infer the user's intent based on the conversational interaction with the user. Based on the inferred user's intent, the systems and methods may present an offer to the user that is likely to be of interest to the user. The user's intent and the offer presented are determined, for example, based on the user's current location, account information, purchase history, the time of day, the user's current location, and the like. As described herein, the conversational interaction with the user may include multiple questions and answers between the user and a financial conversation manager to infer the user's intent and to select an appropriate offer for the user.

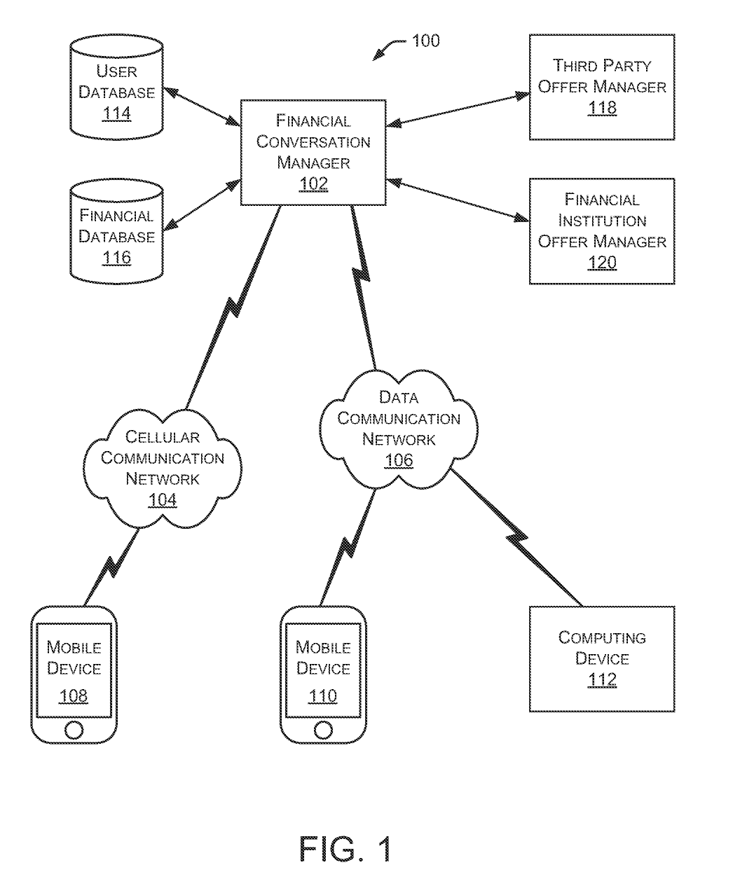

FIG. 1 is a block diagram depicting an environment 100 within which an example embodiment may be implemented. Environment 100 includes a financial conversation manager 102 coupled to a cellular communication network 104 and a data communication network 106, such as the Internet. Users can interact with financial conversation manager 102 using, for example, a mobile device 108, 110 or other computing device 112. Computing device 112 is any type of device capable of communicating with financial conversation manager 102, such as a cellular phone, a smart phone, a tablet computer, a laptop computer, a desktop computer, a portable entertainment device, a portable gaming device, and the like. Although two mobile devices 108, 110 and one computing device 112 are shown in FIG. 1, particular embodiments may include any number of mobile devices and computing devices communicating with financial conversation manager 102 through cellular communication network 104 and/or data communication network 106. Financial conversation manager 102 manages conversational interactions with one or more users to infer the user's intent, and to present an offer to the user based on the user's intent and other factors. Additional details regarding financial conversation manager 102 are discussed herein.

Financial conversation manager 102 is also coupled to a user database 114 and a financial database 116. User database 114 stores information associated with multiple users, such as user preferences, purchase history, demographic information, and the like. Financial database 116 stores information associated with user accounts, financial products and services, financial transactions, and so forth. The information stored in user database 114 and financial database 116 is used by financial conversation manager 102 to, for example, identify a user's intent and make offer recommendations.

A third party offer manager 118 and a financial institution offer manager 120 are also coupled to financial conversation manager 102. Third party offer manager 118 receives information from financial conversation manager 102 and selects one or more offers based on the received information. In some embodiments, third party offer manager 118 is a service offered by an entity different from the provider of the financial conversation manager 102. Financial institution offer manager 120 also receives information from financial conversation manager 102 and selects one or more offers based on the received information. In some embodiments, financial institution offer manager 120 is a service offered by the same entity that provides the financial conversation manager 102. In a particular embodiment, financial institution offer manager 120 is contained within financial conversation manager 102.

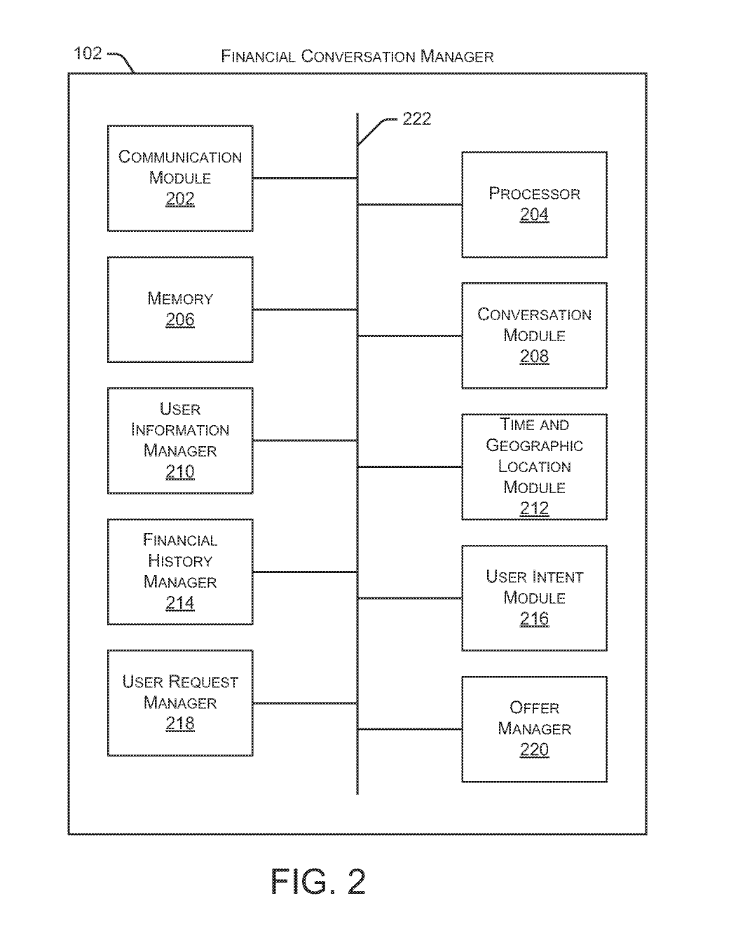

FIG. 2 is a block diagram depicting an embodiment of a financial conversation manager 102. Financial conversation manager 102 includes a communication module 202, a processor 204, and a memory 206. Communication module 202 allows financial conversation manager 102 to communicate with other systems, such as communication networks 104 and 106, offer managers 118 and 120, mobile devices 108 and 110, computing device 112, databases 114 and 116, and the like. Processor 204 executes various instructions to implement the functionality provided by financial conversation manager 102. Memory 206 stores these instructions as well as other data used by processor 204 and other modules contained in financial conversation manager 102.

Financial conversation manager 102 also includes a conversation module 208, which handles the natural language conversation between the user and the financial conversation manager 102. As discussed herein, conversation module 208 may generate questions or requests that are communicated to the user, and receive answers and other statements from the user. Conversation module 208 uses various natural language processing techniques to communicate with the user and to understand the user's statements. A user information manager 210 identifies and maintains information associated with multiple users of the financial conversation manager 102. A time and geographic location module 212 identifies and maintains information related to the current time and the current geographic location of a particular user (e.g., at a coffee shop, restaurant, department store or automobile dealer).

Financial conversation manager 102 further includes a financial history manager 214, which identifies and maintains information associated with a user's financial history (e.g., account history and purchase history). A user intent module 216 infers a user's intent based on a recent conversation, the current time, the user's current geographic location, account history, and other factors. A user request manager 218 handles requests from users and, if necessary, will generate questions for the user to clarify a user's initial request. User request manager 218 operates in conjunction with user intent module 216 to obtain the information necessary to infer a user's current intent. An offer manager 220 handles the generation of and communication of offers to one or more users. In some embodiments, offer manager 220 works in conjunction with third party offer manager 118 or financial institution offer manager 120 to identify appropriate offers for a particular user.

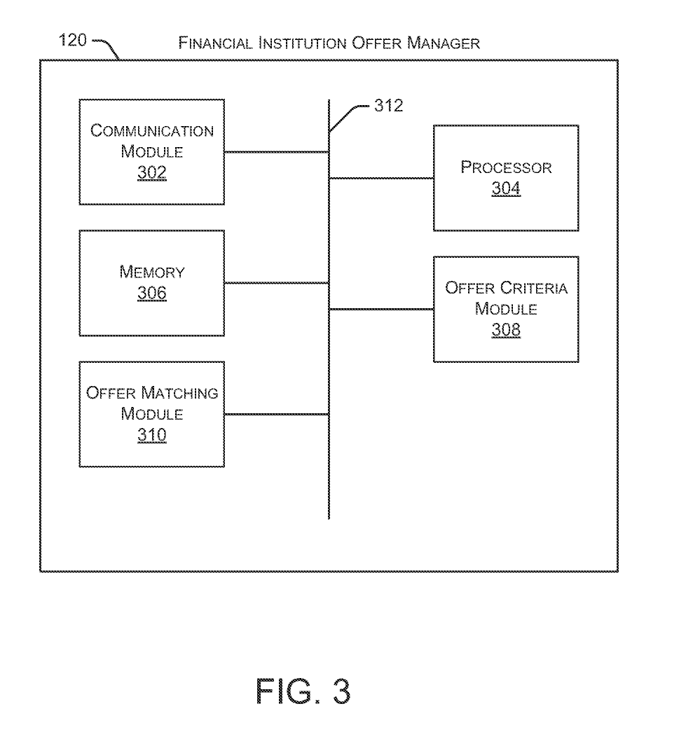

FIG. 3 is a block diagram depicting an embodiment of a financial institution offer manager 120. Financial institution offer manager 120 includes a communication module 302, a processor 304, and a memory 306. Communication module 302 allows financial institution offer manager 120 to communicate with other systems, such as financial conversation manager 102 and various sources of offers (not shown). Processor 304 executes various instructions to implement the functionality provided by financial institution offer manager 120. Memory 306 stores these instructions as well as other data used by processor 304 and other modules contained in financial institution offer manager 120.

Financial institution offer manager 120 also includes an offer criteria module 308, which identifies particular criteria related to various offers. This criteria defines the type of user (or user intent) that is most likely to be interested in the offer. An offer matching module 310 matches a particular offer to a particular user based on the user's current intent and other factors, as discussed herein. Offer matching module 110 works in conjunction with offer criteria module 308 to identify offers that are likely to be of interest to a particular user, and selecting a specific offer to present at the current time. In some situations, offer matching module 310 may not identify an offer match for a particular user. In these situations, offer matching module 310 will indicate to the financial conversation manager 102 that no offer is currently available for the user.

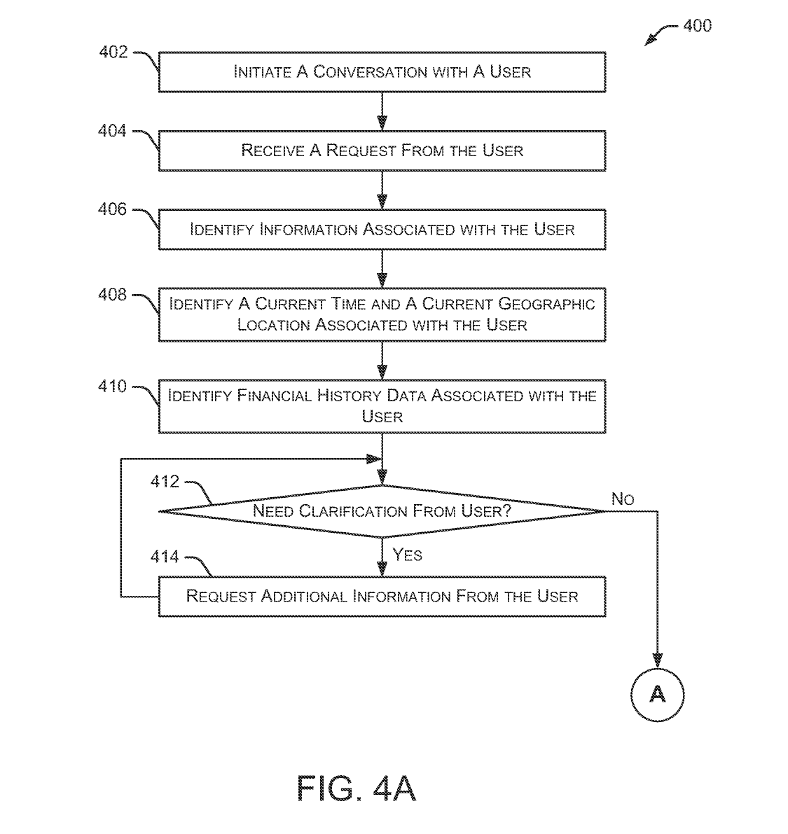

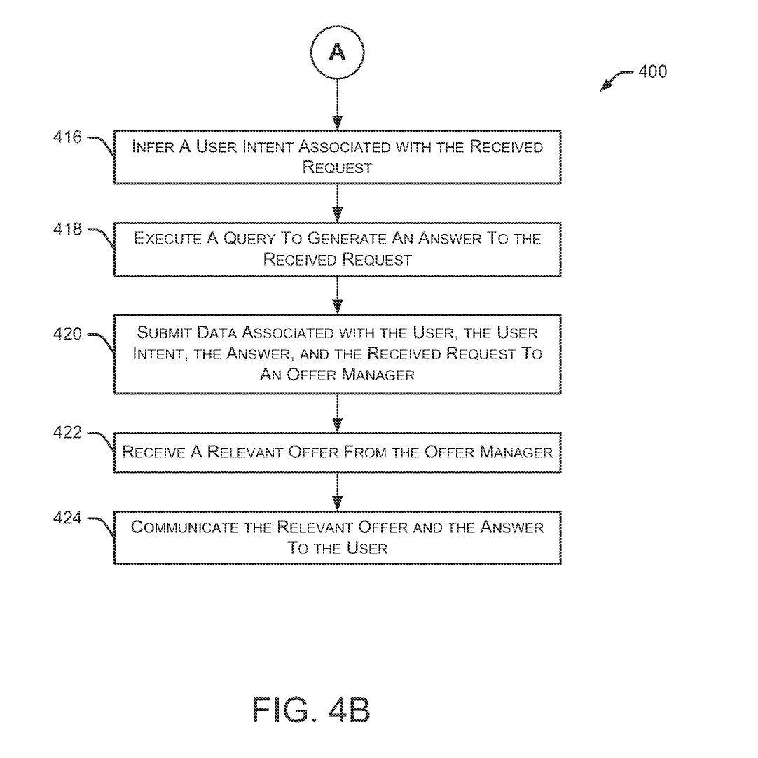

FIGS. 4A and 4B represent a flow diagram depicting an embodiment of a method 400 for interacting with a user and communicating an offer to the user. Initially, a conversation is initiated with a user at 402. For example, a user may contact a financial institution to ask a question about their account with the financial institution. In a particular embodiment, the user accesses the financial conversation manager 102 using mobile device 108, 110 or computing device 112. A request is received from the user at 404. The request may include a question about the balance in an account, spending patterns, available credit, and the like. The method 400 continues by identifying information associated with the user at 406. The identified information may include, for example, user accounts, account balances, available credit, and so forth.

Additionally, the method 400 identifies a current time and a current geographic location associated with the user at 408. In some embodiments, the current geographic location of the user is determined based on GPS (Global Positioning System) data communicated from the user's mobile device 108, 110 or computing device 112 to financial conversation manager 102. The method 400 continues by identifying financial history data associated with the user at 410. The financial history data may include an account history, a purchase history, a loan application history, user spending habits, and the like. Based on the request received from the user and the additional identified information, the method 400 determines, at 412, whether additional clarification is needed from the user to generate a response to the request received from the user. If additional clarification is needed, additional information is requested from the user at 414. For example, to determine a particular intent, multiple pieces of information may be required. If the request received from the user is missing one or more pieces of information, those missing pieces are requested from the user.

If additional clarification is not needed, the method 400 continues at 416 to infer a user intent associated with the received request. The user intent may include, for example, searching for an auto loan, determining monthly spending in a budget category or obtaining a lower interest rate on an existing loan. The method 400 also executes a query to generate an answer to the received request at 418. Data associated with the user, the user intent, the answer to the received request, and the original request received from the user are submitted to an offer manager at 420. The offer manager selects a relevant offer to present to the user based on the information discussed above related to the user and the received request. A relevant offer is received from the offer manager at 422. Finally, the relevant offer and the answer to the user's original request are communicated to the user at 424. In some instances, a relevant offer is not identified for a particular user interaction. In these instances, the answer to the user's original request is communicated to the user at 424 without communicating any offer.

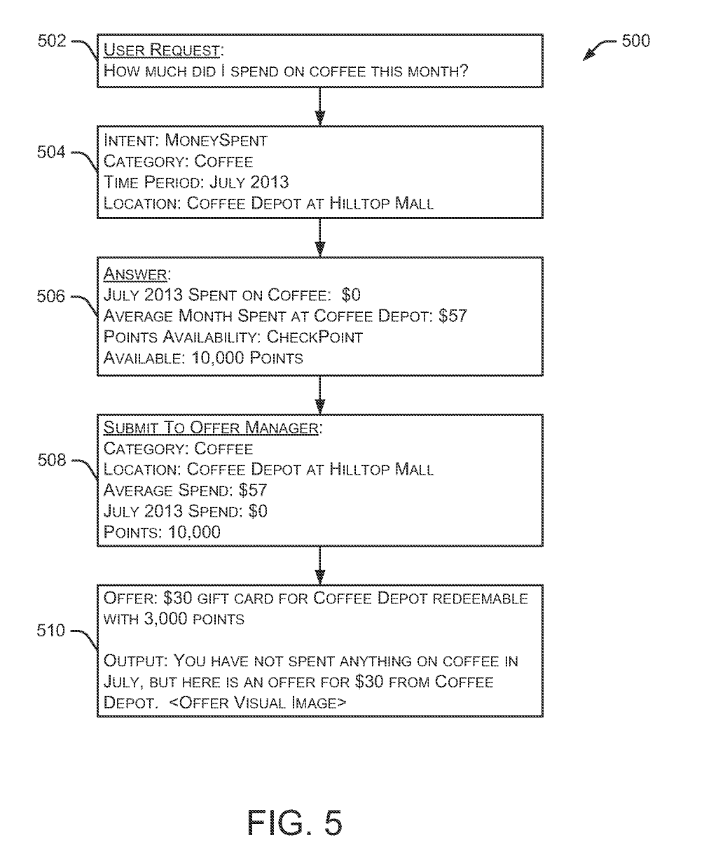

FIG. 5 is a diagram depicting an embodiment of data collected and generated during an interaction 500 with a user. Initially, a user request is received at 502. In this example, the user request states “How much did I spend on coffee this month?” Financial conversation manager 102 identifies a user intent as “MoneySpent” at 504, and identifies a purchase category as “Coffee” and a time period of “July 2013”. Additionally, a current geographic location of the user is determined to be “Coffee Depot at Hilltop Mall”.

An answer to the user request is generated at 506. In this example, the answer indicates “$0” has been spent on coffee in July 2013, the average monthly spending at Coffee Depot is “$57”, and 10,000 reward points are available to the user. At 508, the category (Coffee), current geographic location (Coffee Depot at Hilltop Mall), average spent ($57), July 2013 spent ($0), and available reward points (10,000) are communicated to the offer manager. The offer manager then selects a relevant offer for the user based on the received information. In this example, the offer received at 510 is “$30 gift card for Coffee Depot redeemable with 3,000 reward points”. The information communicated to the user includes the offer as well as the answer to the user's original request. In this example, the information communicated to the user includes “You have not spent anything on coffee in July, but here is an offer for $30 from Coffee Depot.” The information communicated to the user may also include a visual image associated with the offer, such as a Coffee Depot logo, an image of a coupon or an image of a cup of coffee. The user can then choose whether to accept the offer related to Coffee Depot. The offer is likely to be of interest to the user since the user is currently at Coffee Depot and is asking about the amount spent on coffee in the current month.

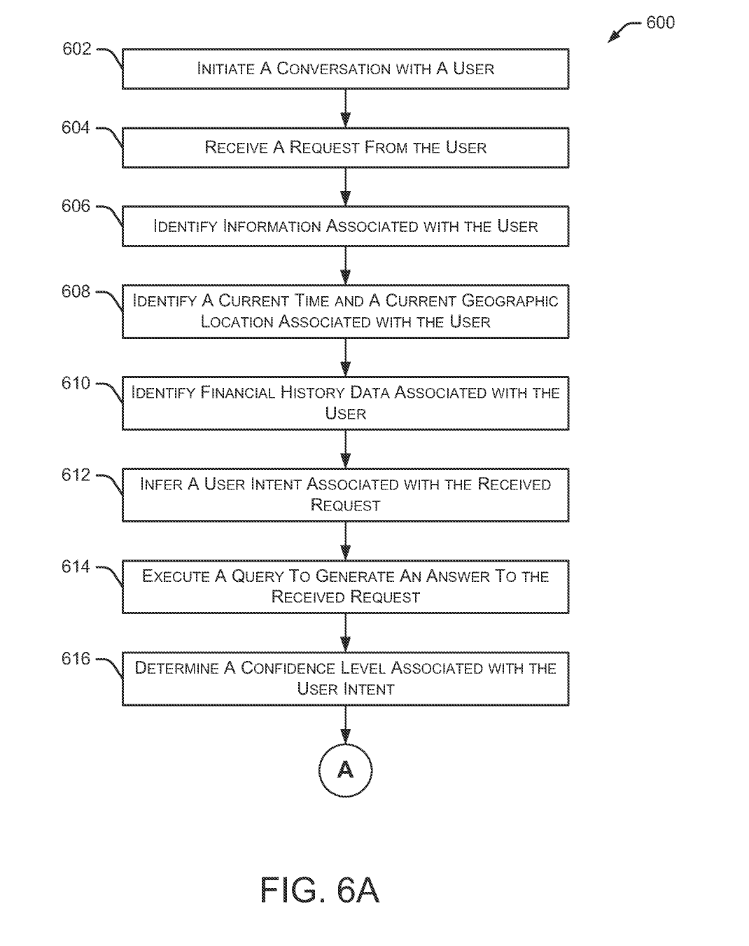

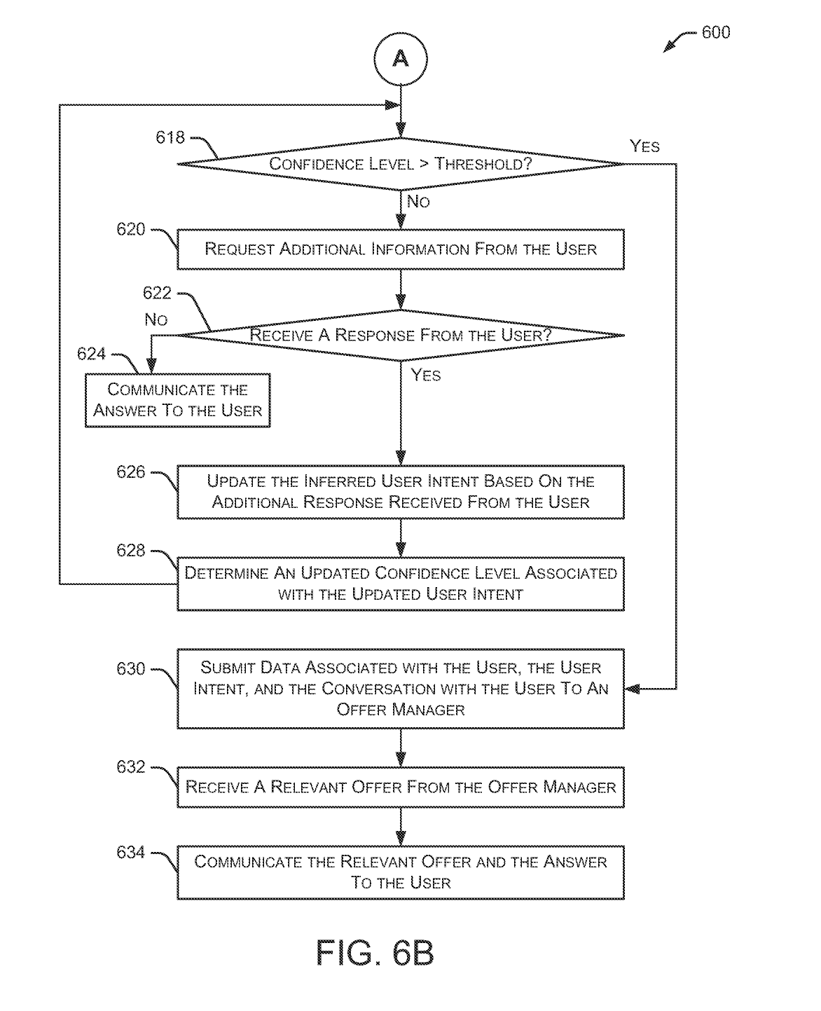

FIGS. 6A and 6B represent a flow diagram depicting another embodiment of a method 600 for interacting with a user and communicating an offer to the user. Initially, a conversation is initiated with a user at 602 and a request is received from the user at 604. The method 600 also identifies information associated with the user at 606, and identifies a current time and a current geographic location associated with the user at 608. Financial history data associated with the user is identified at 610.

The method 600 continues by inferring a user intent associated with the request received from the user at 612. A query is executed at 614 to generate an answer to the request received from the user. Additionally, the method 600 determines a confidence level associated with the user intent at 616. The confidence level indicates the likelihood that the inferred user intent associated with the received request accurately defines the user's current intent when submitting the request. For example, a high likelihood of accuracy would produce a high confidence level. In some embodiments, the confidence level is at least partially determined based on the user's response to one or more previous offers. In a particular implementation, the confidence level is determined by a set of rules that combine the confidences returned by multiple systems evaluating the current user request. These multiple systems include, for example, a parser, a statistical parser (using different machine learning algorithms), and a statistical classifier.

If the confidence level does not exceed a threshold value at 618, the method 600 requests additional information from the user at 620. If, after a predetermined time, a response is not received from the user at 622, the answer is communicated to the user at 624. Thus, if the confidence level is not above the threshold and the user does not provide additional information to support a higher confidence level, the method 600 simply communicates the answer to the user without attempting to obtain a relevant offer from an offer manager.

If a response is received from the user at 622, the method 600 updates the inferred user intent based on the additional response received from the user at 626. An updated confidence level associated with the updated user intent is determined at 628. The method 600 returns to compare the updated confidence level to the threshold value at 618.

If the confidence level exceeds the threshold value at 618, the method 600 submits data associated with the user, the user intent, the answer, and the conversation with the user to an offer manager at 630. A relevant offer is received from the offer manager at 632. Finally, the relevant offer and the answer are communicated to the user at 634. As mentioned above, in some instances, a relevant offer is not identified for a particular user interaction. In these instances, the answer to the user's original request is communicated to the user at 634 without communicating any offer.

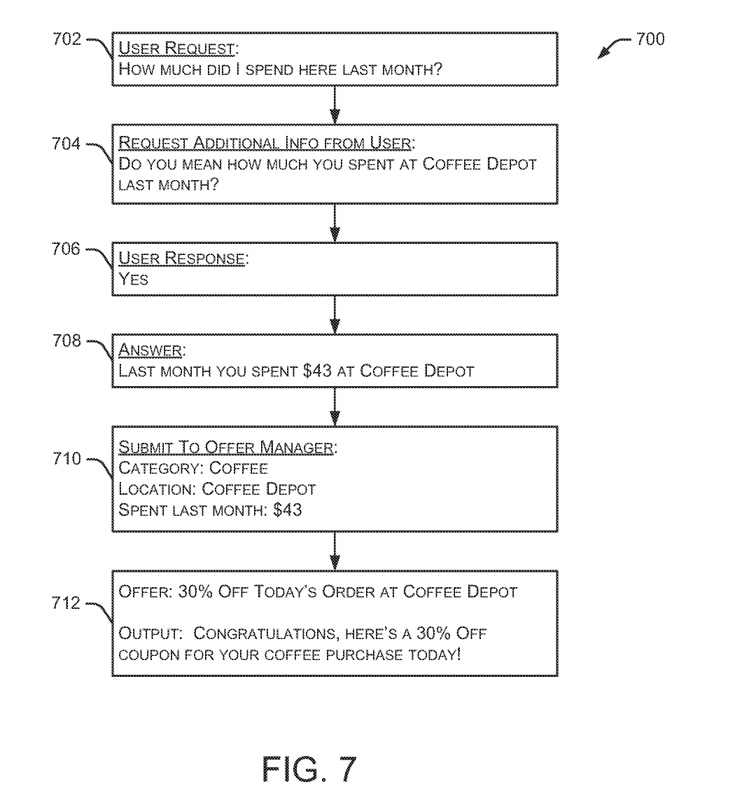

FIG. 7 is a diagram depicting another embodiment of data collected and generated during an interaction 700 with a user. Initially, a user request is received at 702. In this example, the user request states “How much did I spend here last month?” To clarify the user's request, a response is communicated to the user at 704. The response states “Do you mean how much you spent at Coffee Depot last month?” The response specifically mentions “Coffee Depot” since that is the current geographic location of the user. The user responds to the question “Yes” at 706, indicating that the user intent is to determine how much they spent at Coffee Depot in the previous month.

The interaction 700 continues as an answer is determined and communicated to the user at 708. In this example, the answer is “$43”. The category (Coffee), current geographic location (Coffee Depot), and the amount spent at Coffee Depot last month ($43) are communicated to the offer manager at 710. The offer manager selects a relevant offer for the user based on the received information. In this example, the offer received at 712 is “30% Off Today's Order at Coffee Depot”. In this example, the specific information communicated to the user includes “Congratulations, here's a 30% off coupon for your coffee purchase today!” The information communicated to the user may also include a visual image associated with the offer, such as a Coffee Depot logo, an image of a coupon or an image of a cup of coffee. The user can then choose whether to accept the offer related to Coffee Depot. This offer is likely to be of interest to the user since the user is currently at Coffee Depot, spent $43 at Coffee Depot last month, and is asking about past coffee purchases.

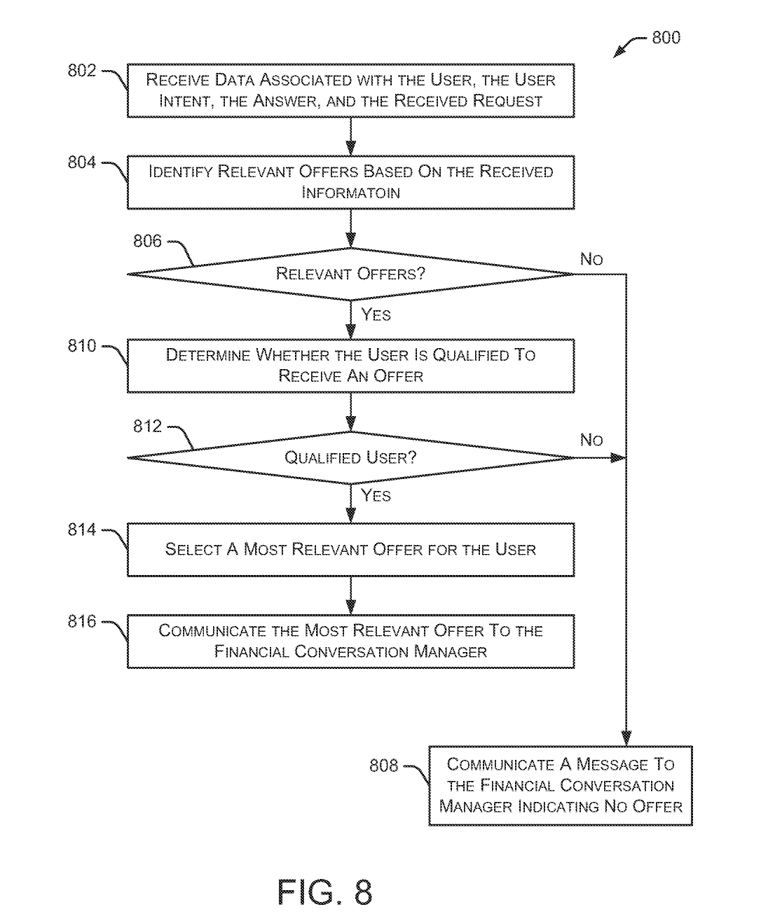

FIG. 8 is a flow diagram depicting an embodiment of a method 800 for selecting an offer to present to a user. Initially, the method 800 receives data associated with the user, the user intent, the answer and the received request at 802. For example, this information may be received from financial conversation manager 102 (FIG. 1). Based on the received information, the method 800 attempts to identify one or more relevant offers at 804. If no relevant offers are identified, the method 800 branches from 806 to 808, where a message is communicated to the financial conversation manager indicating that no offer is available.

If at least one relevant offer is identified at 806, the method 800 continues by determining whether the user is qualified to receive an offer at 810. For example, to qualify for an offer, a user may need to be an existing customer of the entity providing the offer. In other embodiments, qualification of a user for a particular offer is based on how recently the user shopped with the entity providing the offer. For example, an offer may require that the user has recently shopped with the entity, or may require that the user has not shopped with the entity for at least a defined time period (e.g., not shopped with entity during the last 30 days). If the user is not qualified to receive an offer, the method 800 branches from 812 to 808, where a message is communicated to the financial conversation manager indicating that no offer is available.

If the user is qualified at 812, the method 800 continues by selecting a most relevant offer for the user at 814, and communicating the most relevant offer to the financial conversation manager at 816. The financial conversation manager can then present the most relevant offer to the user.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
receiving a request from a user;
identifying financial data associated with the user;
determining an answer to the request from the user based on the financial data associated with the user;
inferring, using one or more processors, a user intent based on the financial data associated with the user and on the request; and
selecting an offer for the user based on the user intent.

2. The method of claim 1, wherein inferring a user intent is further based on the answer to the request from the user.

3. The method of claim 1, wherein determining an answer to the request from the user includes analyzing the financial data associated with the user.

4. The method of claim 1, further comprising communicating the answer and the offer to the user.

5. The method of claim 1, further comprising determining a current geographic location associated with the user, and wherein inferring a user intent is further based on the current geographic location.

6. The method of claim 1, further comprising determining a current time, and wherein determining a user intent is further based on the current time.

7. The method of claim 1, wherein the financial data associated with the user includes financial history data associated with an account associated with the user.

8. The method of claim 1, wherein selecting an offer for the user based on the user intent includes communicating the request, the answer to the request, and the financial data associated with the user to an offer manager.

9. The method of claim 8, wherein the offer manager is associated with a financial institution that received the request from the user.

10. The method of claim 1, further comprising extracting a plurality of intent parameters from the request, wherein inferring a user intent is further based on the plurality of intent parameters.

11. The method of claim 1, further comprising requesting additional information from the user to clarify the user intent.

12. The method of claim 1, wherein the request from the user is a natural language request.

13. A method comprising:
receiving a natural language request from a user;
identifying financial data associated with the user responsive to the request;
determining an answer to the natural language request from the user;
inferring, using one or more processors, a user intent based on the financial data associated with the user;
determining a confidence level associated with the user intent;
determining whether the confidence level exceeds a confidence threshold; and
responsive to determining that the confidence level exceeds the confidence threshold, selecting an offer for the user based on the user intent.

14. The method of claim 13, wherein responsive to determining that the confidence level does not exceed the confidence threshold, requesting additional information from the user regarding the request.

15. The method of claim 13, further comprising communicating the selected offer to the user responsive to determining that the confidence level exceeds the confidence threshold.

16. The method of claim 13, further comprising determining a current geographic location associated with the user, and wherein inferring a user intent is further based on the current geographic location.

17. The method of claim 13, further comprising determining a current time, and wherein inferring a user intent is further based on the current time.

18. The method of claim 13, wherein selecting an offer for the user based on the user intent includes communicating the natural language request, the answer to the request, and the financial data associated with the user to an offer manager.

19. The method of claim 13, wherein determining a confidence level associated with the user intent includes identifying the user's response to previous offers.

20. A financial conversation management system comprising:
a memory configured to store data associated with at least one user conversation; and
one or more processors coupled to the memory, the one or more processors configured to:
receive a request from a user;
identify purchase data associated with the user, responsive to the request;
determine a current geographic location associated with the user;
determine an answer to the request from the user;
infer a user intent based on the purchase data associated with the user and the current geographic location of the user; and
select an offer for the user based on the user intent.
